(19) United States
(12) Patent Application Publication
(10) Pub. No.: US 2009/0183475 A1
(43) Pub. Date: Jul. 23, 2009

(54) PLEATED RECIRCULATION FILTER

(76) Inventors: EDWIN G. DAUBER, Chesapeake City, MD (US); Rajan Gidumal, Newark, DE (US); Anthony P. LoCurcio, Newark, DE (US)

Correspondence Address: GORE ENTERPRISE HOLDINGS, INC., 551 PAPER MILL ROAD, P. O. BOX 9206, NEWARK, DE, 19714-9206, US

(21) Appl. No.: 12/017,520

(22) Filed: Jan. 22, 2008

(51) Int. Cl. B01D 46/52; B32B 3/12; B32B 37/00

(52) U.S. Cl. 55/385.6; 156/197

(57) ABSTRACT

The invention relates to a device for filtering contaminants, such as particulates and vapor phase contaminants, from a confined environment such as electronic or optical devices susceptible to contamination (e.g. computer disk drives) by providing an improved performance recirculation filter.

### BACKGROUND OF THE INVENTION

Many enclosures that contain sensitive instrumentation must maintain very clean internal environments in order for the equipment to operate properly. Examples include enclosures with optical surfaces or electronic connections that are sensitive to particles or gaseous contaminants that interfere with mechanical, optical, or electrical operation. Other examples include data recording devices such as computer hard disk and drives and optical drives that are sensitive to particles, organic vapors, or corrosive vapors. Still others include enclosures for processing, transporting or storing thin films and semiconductor wafers. Electronic control boxes, such as those used in automobiles and industrial applications, can also be sensitive to particles, moisture buildup, or corrosion as well as contamination from fluids and vapors. Contamination in such enclosures originates from sources both inside and outside the enclosure. For example, in computer hard drives, damage may result from external contaminates as well as from particles and outgassing generated from internal sources. The terms “hard drives” or “hard disk drives” or “disk drives” or “drives” will be used herein for convenience and are understood to include any of the enclosures mentioned above.

To address contamination problems, internal particulate filters, or recirculation filters, are installed in disk drives. These filters may incorporate filter media, such as expanded PTFE membrane laminated to backing material such as a polyester nonwoven, or “pillow-shaped” filters containing electret (i.e. electrostatic) filter media or triboelectret media. Electret and triboelectret media are collectively described herein as “electret media”. These “pillow-shaped” filters may be pressure fit into slots or “C” channels preferably in the active air stream generated by the rotating disks in a computer hard disk drive or fans in electronic control cabinets, etc. Some recirculation filters include a plastic frame around the perimeter of the filter media.

Recirculation filters for computer hard disk drives may also consist of one or more layers of electret media with one or more layers of scrim on either side of the electret layer. The outer scrim layer or layers are used to contain the fibers of the electret layer as well as add stiffness for ease of handling, or ease of manufacturing.

Larger drives such as the 5.25″ drives and larger that were built many years ago also sometimes incorporated a recirculation filter consisting of filter material, often pleated and sealed or potted into a plastic housing where a sealant or potting material was used to hold and position the pleats as well as seal the media to the plastic housing. The plastic housings and potting material used to seal the media made the filters relatively expensive and complex. Many steps and operations were needed to make and install these filters. These filters are impractical in the smaller drives where space is limited and low cost is desirable.

Electret filter layers may be constructed of electret fibers needled into a scrim. Such electret filter layers are often specified by two parameters: the weight per unit area of electret fibers needled into the scrim, and the weight of the scrim. A typical scrim weight is 15 grams per square meter, but other weights are available. Common electret media fibers may be from about 23 grams per square meter to about 270 grams per square meter, although other material weights are available. Other electret layers may be scrimless electret layers, entangled electret fibers or spunbond electret fibers. Fibers may be charged during their manufacturing to improve filter performance.

Electret filter layers can also be specified by filtration performance or by both filtration efficiency and resistance to airflow or permeability. Typically efficiency is specified for a particular particle size at a particular airflow. For example, a 90 gram per square meter of felt needled into a 15 gram per square meter scrim may be at least 80% efficient for 0.1 micron sized particles at an airflow of 10.5 feet per minute. Resistance may be specified at a specific airflow. For example the 90 gram felt described above may have a maximum resistance of 0.35 mm water at an airflow of 10.5 feet per minute.

Filter performance may also be a function of filter material weight. Higher basis weight materials may have a higher efficiency, but also a higher pressure drop or resistance to airflow. The thickness of the filter is also important for electrostatic media. Thicker media with more loft may have a lower pressure drop and higher efficiency than media of similar basis weight. Thus thicker filters may have reduced clean up time.

The performance of the filter is not only dependent upon the filter material, but also the location of the filter within the drive and how well the air is directed towards the filter in the drive design. Particle filters may be installed into a drive by placing them in c-channels, which are either molded into the drive base plate or molded into a plastic box or frame that holds the filter. Air may be channeled into a slot or region of the drive where the filter is placed so that particle laden air passes through the filter. Typically the filter will be sized to allow it to extend from the drive top cover to the base plate.

Newer drives are increasingly sensitive to particle contamination. The head is positioned closer to the disk, because more data information can be stored within a smaller area or footprint on the disk. If the “flying height ” of the head is reduced, protective layers are thinner to allow the head to get closer to the magnetic layers where the data is stored. Accordingly, these drives continue to become more and more sensitive to particle contamination and improved filtration performance is necessary.

In one aspect, an improved single piece pleated recirculation filter that is dimensionally stable is provided. The filters can be easily made and installed into existing c-channels without drive modifications and can significantly improve particle clean-up performance.

The present invention thereby provides an improved recirculation filter that reduces particle contaminations inside the drive and increases drive reliability.

### SUMMARY

In one aspect, recirculation filter for a disk drive is provided. The recirculation filter comprises filtration media having a first end and a second end opposite the first end, pleats extending from the first end to the second end, in which each of the first end and second end of said filtration media have a substantially planar stiffening edge, the stiffening edge interconnecting the pleats. In another aspect, the disk drive recirculation filter comprises at least one tab extending from said filter.

### BRIEF DESCRIPTION OF THE DRAWINGS

The operation of the present invention should become apparent from the written description when considered in conjunction with the following drawings, in which:

FIG. 1 is a cross section of an exemplary filter media.

FIG. 1A is a cross section of another exemplary filter media including an adsorbent layer.

FIG. 2 is a cross section of an alternative filter media.

FIG. 3 is an isometric view of an embodiment of the filter.

FIGS. 4A and 4B are a top cross sectional and side view respectively of an embodiment of the filter.

FIG. 5 is an isometric view of another embodiment of the filter unit of the present invention that comprises a pleated filter with a sealed welded media perimeter border around the perimeter of the filter with the pleats running parallel to the long dimension of the filter.

FIG. 6 is an isometric view of another embodiment of the present invention with sealed welded media edges on two ends of the filter with the pleats running perpendicular to the welded edges.

FIG. 7 is a top cross sectional view of the filter illustrated in FIG. 3 as it may be located in the c-channels typically used to hold the filter in place in the drive.

FIG. 8 is a top view of a filter of the present invention installed in a drive which also includes the disk storage media, armature and read/write head.

FIG. 9 is a side view of another embodiment of the filter unit of the present invention that comprises a pleated filter with a sealed welded media perimeter border around the perimeter of the filter further comprising two tabs extending from opposing sides of the filter.

FIGS. 10a and 10b are a top cross sectional and side view respectively of the embodiment illustrated in FIG. 9 installed into c-channels that can hold the filter inside of a drive.

### DETAILED DESCRIPTION OF THE INVENTION

This invention relates to a device for filtering particulates from an enclosure containing electronic or optical devices susceptible to contamination, (e.g. computer disk drives). Specifically, the invention provides an improved recirculation filter for a disk drive.

Pleated electret media may allow for more media in a given space and a reduced face velocity through the media for any given volumetric flow, thereby improving filtration performance. Edge sealing the pleated media may add dimensional stability to make the filter easy to install even with automated pick and place type equipment.

The preferred embodiments of the present invention are now described in detail with reference to the drawings. Like reference numbers represent like parts, layers and constructions.

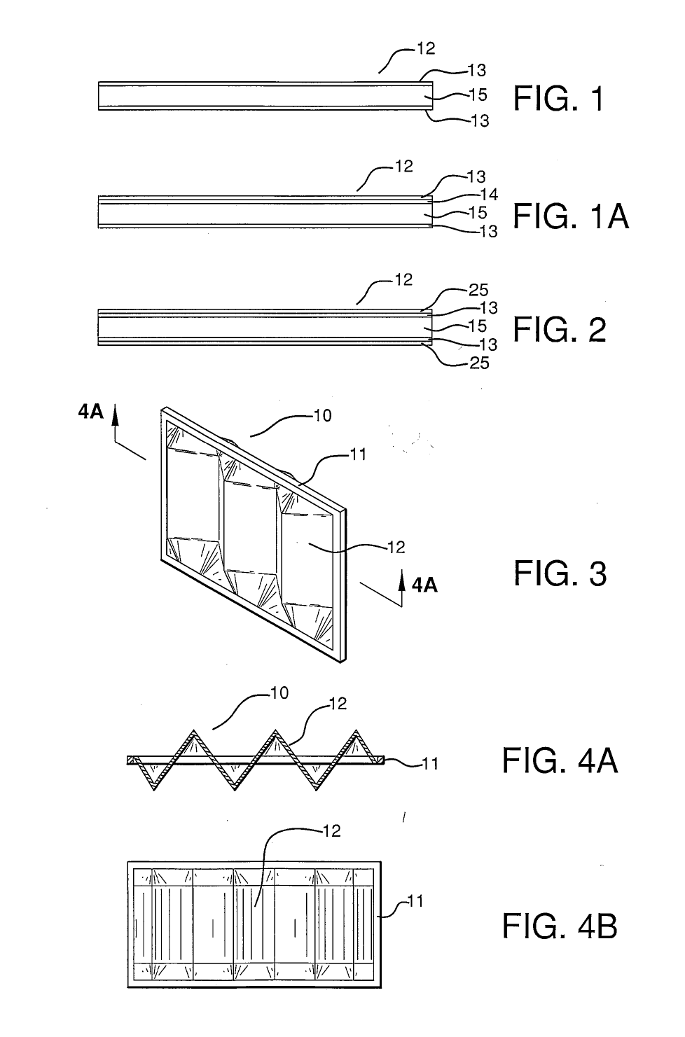

FIG. 1 shows a cross section of exemplary filter media 12 prior to pleating. Electret media 15 is covered on each side with cover layer 13. Cover layers 13 may surround the electret media to improve filter performance, contain the fibers of the electrostatic media layer or layers and add stiffness. FIG. 1A shows another embodiment of filter media in which adsorbent layer 14 is added. FIG. 2 shows still another embodiment of filter media where a second cover layer 25 is added to either side of the media stack depicted in FIG. 1.

Electret media may comprise a felt layer. Felt weights in the 23 grams per square meter to 270 grams per square meter are preferred, felts in the ranges of 50 grams per square meter to 210 grams per square meter are more preferred, and felts in the range of 70 grams per square meter to 180 grams per square meter are most preferred.

In another aspect, filter media 12 may comprise a layer or layers of expanded PTFE membrane that may be optionally laminated to a support material such as a spun bonded polyester nonwoven. Expanded PTFE media may be used with or without cover layer 13 or adsorbent layer 14.

Cover layer 13 may be a membrane such as ePTFE. Membrane cover layers may improve filtration enhancement, fiber containment, or adsorbent containment in any of the embodiments. Membrane cover layers may be included as an extra layer or may be laminated to any of the other filter layers.

A preferred membrane is expanded PTFE membrane made as described in U.S. Pat. No. 4,902,423 to Bacino et al. Such membranes are available in finished form from W. L. Gore and Associates, Inc. in Elkton Md. This membrane has minimal resistance to airflow yet contains fibers well when laminated to a filter or support layer. This membrane may also offer additional mechanical filtration for the filter to supplement the electrostatic filtration mechanism of the electrostatic layer or layers contained in the filter media of the present invention. This can become important for particles which are difficult to collect with an electrostatic filter media. For example, particles that are traveling very fast or are of a size and charge that is difficult for electrostatic filter media to collect may be more readily removed by membrane media.

Cover layers 13 and/or 25 may comprise any scrim, screen, woven or nonwoven material or combination thereof. A preferred cover layer is a scrim that is point bonded or spun bonded material such as a polypropylene. Such materials are commercially available from BBA Fiberweb Americas in Old Hickory, Tenn. in various material weights. A preferred cover scrim will contain fibers and add minimal pressure drop across the filter. Preferred weights of scrims may be 10 grams per square meter to 100 grams per square meter. Preferably, covering scrim material is about 20 gram per square meter to about 50 grams per square meter.

As shown in FIG. 2, an adsorbent layer 14 or layers may be added to any of the embodiments described above, to make a combination filter effective for both particle and vapor filtration. The adsorbent of adsorbent layer 14 may be treated for the adsorption of specific gaseous species such as acid gasses.

The adsorbent may comprise pure adsorbent materials, such as granular activated carbon, or may be a filled product matrix such as a scaffold of porous polymeric material compounded with adsorbents that fill some of the void spaces. Other possibilities include adsorbent impregnated nonwovens or beads on a scrim where the non-woven or scrim may be cellulose or polymeric and may include latex or other binders. Still other possibilities include porous castings or tablets of adsorbents and fillers that are polymeric or ceramic. Further possibilities are woven or nonwoven materials made from carbon or carbonized fibers. The adsorbent can also be a mixture of different types of adsorbents.

Examples of adsorbent materials that may be contained within the adsorbent layer include: physisorbers (e.g. silica gel, activated carbon, activated alumina, molecular sieves, adsorbent polymers, etc.); chemisorbers (e.g. potassium permanganate, potassium carbonate, potassium iodide, calcium carbonate, calcium sulfate, sodium carbonate, sodium hydroxide, calcium hydroxide, powdered metals or other reactants for scavenging gas phase contaminants); as well as mixtures of these materials. The adsorbents can also be treated to alter the surface chemistry to adjust adsorption of polar or non-polar adsorbates such as moisture. For some applications, it may be desirable to employ multiple layers of adsorbent materials, with each layer containing different adsorbents to selectively remove different contaminants as they pass through the filter.

A preferred embodiment of the adsorbent layer utilizes a sorbent filled PTFE sheet wherein the sorbent particles are entrapped within the reticular PTFE structure as taught by U.S. Pat. No. 4,985,296 issued to Mortimer, Jr. and incorporated herein by reference. Ideally, particles are packed in a multi-modal (e.g. bi-modal or tri-modal) manner with particles of different sizes interspersed around one another to fill as much of the available void space between particles as is possible, so as to maximize the amount of active material contained in the core. This technique also allows a number of sorbents to be filled into a single layer. The core can then be expanded to allow some airflow or needled to allow more airflow. Expanding the core may reduce loading density but offers a more uniform sorbent barrier. Other processing, such as needling or the like, may be desirable to obtain the desired adsorbent and airflow performance.

The PTFE/adsorbent composite can easily be made in thicknesses from less than 0.001″ to 0.400″ and greater allowing a great deal of flexibility in finished filter thickness and adsorbent loading. Additionally, sorbent densities approximating 80-95% of full density are possible with multi-model packing and physical compression, so that maximum adsorbent material can be packed per unit volume. The use of PTFE as the binding element also may not block the adsorbent pores as do binders such as acrylics, melted plastic resins, etc.

Additional layers may be added to filters for dimensional stability, fiber containment, filter stiffness, visual enhancements for visual verification of placement, or ease of handling the filter robotically for automated installation. Additional filtration layers may also be added to enhance either the filtration for certain particles or used as filtration functional covers, scrims and support layers without departing from the spirit of the invention.

FIG. 3 is an isometric view of the unit 10 of the present invention showing a center section having pleated media 12 and the sealed perimeter 11, sealed perimeter 11 may add dimensional stability to the pleated filter 10. The pleats in this embodiment are perpendicular to the long side of the rectangular filter unit 10. FIG. 4A is a top cross-sectional view and 4B is a side view of the same embodiment of the filter unit 10.

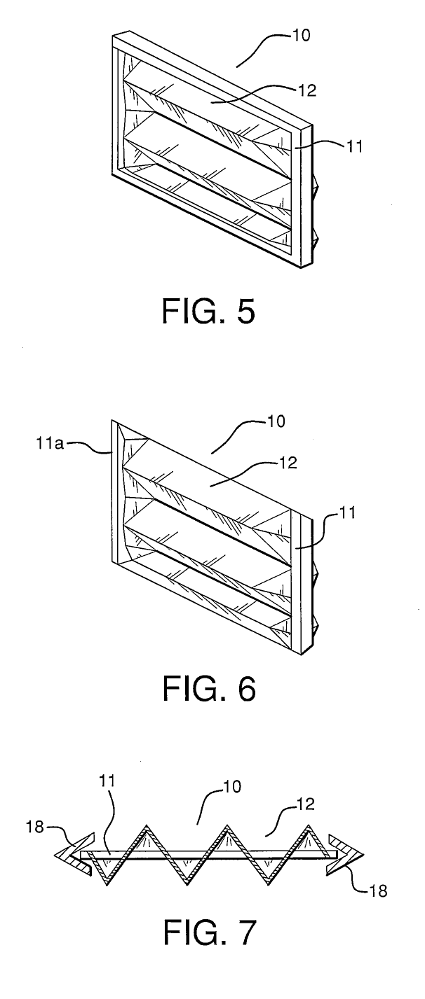

FIG. 5 is an isometric view of another embodiment of the filter unit 10 of the present invention that comprises a rectangular pleated filter unit with a sealed perimeter 11 where the pleats are parallel to the long side of the filter unit 10.

FIG. 6 is an isometric view of another embodiment of the filter unit 10 that comprises a pleated filter unit with only two sealed edges where the pleats are perpendicular to the sealed edges 11 and 11a. In this embodiment, the pleats are stabilized by two sealed edges 11, 11a. In another embodiment only one of the two edges may be sealed. The filter would still have some dimensional stability, but not as much as would be provided with the two opposing sealed edges perpendicular to the pleats.

FIG. 7 is a top cross sectional view of an embodiment of filter 10 shown as it would be placed and held in a disc drive between oppositely placed c-channels 18.

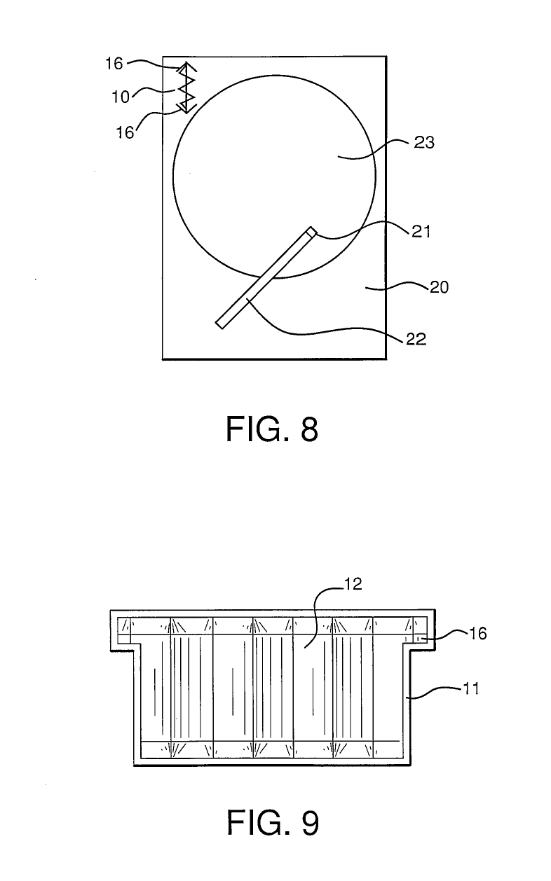

FIG. 8 is a top view of an embodiment of the present invention shown as it could be placed inside a disc drive 20. Disc drive 20 includes the reading and recording head 21 on an armature 22 over the recording disk 23.

The filter may be of any shape and need not be rectangular. For example, FIG. 9 is a side view of another embodiment of the filter unit of the present invention that comprises a pleated filter with a sealed welded media perimeter border around the perimeter of the filter further comprising two tabs 16 extending from opposing sides of the filter. This illustrates two tabs but any filter with one or more tabs or other configuration could be utilized. Tabs can be small or large features, and may be utilized for several functions. The tabs illustrated here may advantageously fit over c-channels in the device, as illustrated in FIG. 9. This may help seal the filter and reduce the probability of air flow and particles flowing over top the c-channels. It also adds filter area, increasing the filter effectiveness. Tabs may also be used on the sides to form an interference fit between the filter and the c-channels to help hold the filter in place.

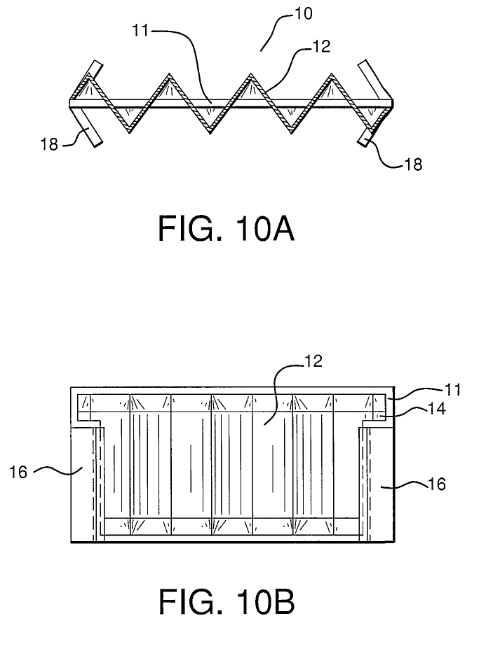

FIGS. 10A and 10B are a top and side view respectively of the embodiment illustrated in FIG. 9 installed into c-channels 18.

These pleated filters with a sealed reinforcing edge may be made by any of several methods. Pleating machines will pleat and set the filter media in a corrugated or pleated pattern. Then the pleated filter material may be die cut and at least one edge sealed to hold the pleats. Sealing may be done by application of heat and pressure or by other means that fuse the material layers. The sealing and cutting may be done in one or two steps: a sealing step may be followed by a cutting step. Alternatively, a single step process of cutting and sealing the edge with heat and pressure may be used. Ultrasonics, laser cutting and other cutting and sealing methods may be used in either a one step or a two step method. Alternatively, the filter layers could be corrugated or pleated and sealed all in a single process with mated tooling that pleats or gathers the media and cuts and seals the edge or edges of the filter.

### Disk Drive Recirculation Filter Test:

This test is designed to measure the effectiveness of a particle filter in reducing the particle concentration inside a disk drive from an initial state in which the drive has been charged with particles. The test used herein is recommended by International Disk Drive Equipment and Materials Association for testing and comparing the performance for recirculation filter clean-up time in hard disk drives. The performance of the recirculation filter is quantified in terms of a cleanup time, which is defined as the time required to reduce the particle counts inside the drive to a percentage of their initial value. Typically clean up time is the time required to remove 90% of the particles in a drive and is referred to as a t₉₀ value. Lower t₉₀ values indicate faster clean up and improved filter performance.

To test the effectiveness of the recirculation filter, the filter samples were tested in the modified disk drive. The existing breather hole in the drive was left uncovered in order to provide a means for venting any overpressure from the drive and to allow air to enter the drive during periods when the drive environment was being sampled without air being purposefully introduced into the drive. The lid was fastened securely to the base plate. A tube supplying an aerosol of 0.1 μm and 0.5 μm particles was connected to the inlet port in the drive lid upstream of the filter based on the direction of disk rotation. The particles were 0.1 μm and 0.5 μm polystyrene latex spheres supplied by Duke Scientific Corporation. The particles were diluted in deionized water and atomized with an atomizer supplied by TSI Corporation. A second tube for sampling the internal atmosphere of the drive connected the laser particle counter (LPC) to the outlet port in the drive lid downstream of the filter. A Model HS-LAS laser aerosol spectrometer from Particle Measuring Systems Inc. was used to count the particles. Sample flow rate out of the drive and through the counter was maintained by precision mass flow controllers at 0.833 cc/sec and sheath flow through the LPC was maintained at 15 cc/sec. Counts of particles were obtained once per second by the LPC and stored on a computer disk drive for analysis. The test was performed with the drive located in a laminar flow hood fitted with a HEPA filter in the air intake, to maintain a controlled test environment with an extremely low ambient particle concentration.

The recirculation filter test consisted of the following sequence: With the drive turned off, particle laden air was passed through the drive. The counts of particles were monitored until a steady state count was achieved, typically around 2000 to 3000 counts per second for the 0.1 μm sized particles and about 1000 counts per second of 0.5 μm particles. This steady state count is defined as Ca. The drive then is turned on and the counts are monitored until a new steady state is obtained and that is defined as Css. The drop in concentration is due to the recirculation of air through the drive and particle collection on the filter, impaction of the particles on drive surfaces and other particle collection means. A ratio of Ca/Css is then calculated. A T₉₀ time is then calculated by the following equation where V_{drive}=the volume of air in the drive which for many 3.5″ drives is around 100 cc, and Qᵢₙ=the flow rate of the air into the drive which is usually assumed to be equal to the flow rate into the particle counter as long as the drive is maintaining a relatively atmospheric internal pressure which in our case was 0.833 cc/sec:

$${t}_{90} ( Disk drive + RecirculationFilter ) = ( \frac{2.3 * {V}_{drive}}{{( \frac{{C}_{a}}{{C}_{SS}} )}_{with filter} - 1} ) \frac{1}{{Q}_{in}}$$

Filter performance may be represented by the relative clean up ratio of the filter (RCUR).

RCUR is calculated by dividing the too time of the drive plus filter by the t₉₀ time measured with no filter. The t₉₀ time of the drive only is calculated using a similar equation to the one above except the Ca and Css are steady states reached without a filter in the drive. By comparing the clean-up time for the filter in a drive to the drive without a filter, the effect of the filter is isolated, and different filters may be compared. Lower RCUR values may indicate better performance.

At least two individual tests were performed in order to check reproducibility and eliminate error from noise in the background counts. The results from the two tests were averaged to obtain the average cleanup times for 0.1 μm particles. Air was sampled from the drive to the particle counter and particle laden air enters the drive through the inlet port. Particles will impact on drive surfaces or eventually settle out of the air stream as well as collect on the filter when the filter is in place.

### Assembly of the Device Into a Modified Drive:

Examples of the present invention were tested for particulate filtration performance using a commercially available 3.5 inch form factor 7200 rpm disk drive from Seagate Technologies with two disks. Modification consisted of drilling two holes in the drive lid. One hole was used to allow the introduction of particles, and another to sample the internal drive atmosphere during the performance testing. Installed over each of the holes in the lid was a stainless steel fitting, the fittings were centered, one over each hole and attached and sealed using two-component epoxy. Tubing was used to connect the particle supply source to the drive inlet fitting and to connect the particle counter to the outlet fitting. The drive lid was cleaned using isopropanol and clean pressurized air to remove any oils and particles created during modification. Following modification of the drive, the filters were placed into the c-channels in the drive.

Each sample was tested in the same 3.5″ drive in the same recirculation filter location. All filter samples were the same dimensions as the filter supplied in the drive. Three inventive examples were constructed and tested. A non pleated filter substantially similar to that as supplied in the drive was also tested. The drive was also tested without any filter to isolate the filter performance.

### EXAMPLE 1

The recirculation filter effectiveness of the inventive recirculation filters were evaluated and compared to a conventional recirculation filter (i.e. are constructed of materials similar to the original filter supplied in the test drive as purchased). A filter as shown in FIG. 3 was made and comprised an electret filter media layer between two layers of 0.75 ounce/square yard polypropylene nonwoven layers. The electret layer was comprised of a 15 gram per square meter scrim with 90 grams per square meter electret felt material needled through it (this construction is commercially available from Hollingsworth and Vose Company in Walpole Mass.). The electret media was an approximate blend of 50% polypropylene and 50% acrylic cut staple fibers needled into the scrim. The polypropylene non woven layer was a UNIPRO™ spunbond polypropylene available from Midwest Filtration in Cincinnati, Ohio. The three layers were then pleated on a PLEATMASTER™ pleater (commercially available from Karl Robofsky America Corp. in South Easton Mass.). Pleat amplitude was adjusted to about 5 mm. The pleated media was then heat welded and die cut about the perimeter. A sealed border was made on all four sides by the heat seal process. The finished filter was 15.75 mm tall and 22.61 mm wide. The finished filter contained four complete pleats comprising four pleat peaks and four pleat valleys. The filter was tested using the Disk Drive Recirculation Filter Test described herein. A no filter test was run as another control to isolate the performance of the filter from other aspects of the test. The results are reported in Table 1 below.

### EXAMPLE 2

A second filter was made similar to Example 1 except that the electret media was placed between two layers of Delnet 0707-30P, a commercially available scrim purchased from DelStar in Middletown, Del. The three layers were pleated and die cut as in Example 1 with four complete pleats in the filter. The results are reported in Table 1 below.

### EXAMPLE 3

A third sample was made using the materials of Example 2. However, the finished filter had six complete pleats. The filter was tested using the Disk Drive Recirculation Filter Test described herein. A no filter test was run as another control to isolate the performance of the filter from other aspects of the test. The results are reported in Table 1 below.

### COMPARATIVE EXAMPLE 1

A non-pleated filter was used for comparison. The comparative filter was also 22.61 mm wide by 15.75 mm tall. The filter material was a five layer construction similar to that supplied in the drive: a single layer of approximately 90 weight electret felt used in the above examples. Two layers of nonwoven polyester were placed on either side of the electret material. The outer layers were a polypropylene scrim. The filter was tested using the Disk Drive Recirculation Filter Test described herein. The results are reported in Table 1 below.

TABLE 1

| | 0.1 micron particle | | | | | | | | | | | |
|---|---|---|---|---|---|---|---|---|---|---|---|---|
| | | | | | Ave. | | 0.5 micron particle | | | | | |
| | | | | T90 | t90 | | | | | T90 | Ave | |
| | Ca | Css | Ca/Css | (sec) | (sec) | RCUR | Ca | Css | Ca/Css | (sec) | t90 | RCUR |
| No Filter | | | | | | | | | | | | |
| Run-1 | 1767.3 | 282.7 | 6.252 | 52.6 | 53.2 | N/A | 844.4 | 152.8 | 5.526 | 61.0 | 62.4 | N/A |
| Run-2 | 1756 | 286.3 | 6.133 | 53.8 | | | 831.3 | 155.9 | 5.332 | 63.7 | | |
| Comparative | | | | | | | | | | | | |
| Example 1 | | | | | | | | | | | | |
| Run-1 | 1785.7 | 51.8 | 34.47 | 8.2 | 8.1 | 0.15 | 856.3 | 17.3 | 49.49 | 5.7 | 5.7 | 0.09 |
| Run-2 | 1803.4 | 50.6 | 35.64 | 8.0 | | | 877.1 | 17.6 | 49.83 | 5.7 | | |
| Example 1 | | | | | | | | | | | | |
| Run-1 | 2560.2 | 38.2 | 67.02 | 4.2 | 4.3 | 0.08 | 1314.7 | 13.9 | 94.58 | 3.0 | 3.1 | 0.05 |
| Run-2 | 2171.8 | 33.5 | 64.83 | 4.3 | | | 1147.9 | 13.1 | 87.62 | 3.2 | | |
| Example 2 | | | | | | | | | | | | |
| Run-1 | 2012.1 | 30.6 | 65.75 | 4.3 | 4.3 | 0.08 | 1112.3 | 12.1 | 91.92 | 3.0 | 3.0 | 0.05 |
| Run-2 | 2014.5 | 30.9 | 65.194 | 4.3 | | | 1128.8 | 12.2 | 92.525 | 3.0 | | |
| Example 3 | | | | | | | | | | | | |
| Run-1 | 1762 | 24 | 73.417 | 3.8 | 3.8 | 0.07 | 927.3 | 9.2 | 100.793 | 2.8 | 2.7 | 0.04 |
| Run-2 | 1832.3 | 24.4 | 75.094 | 3.7 | | | 983.2 | 9.6 | 102.417 | 2.7 | | |

The inventive improved recirculation filters showed significant performance improvement over known electret media constructions by from 46.9% to 53.1% for 0.1 micron sized particles and from 35.1% to 52.6% for 0.5 micron sized particles or cut the time required to clean the drive of these particles about in half.

While particular embodiments of the present invention have been illustrated and described herein, the present invention should not be limited to such illustrations and descriptions. It should be apparent that changes and modifications may be incorporated and embodied as part of the present invention within the scope of the following claims:

We claim:

1. A recirculation filter for a disk drive comprising:
a) filtration media having a first end and a second end opposite the first end,
b) pleats extending from the first end to the second end, each of the first end and second end of said filtration media having a substantially planar stiffening edge, the stiffening edge interconnecting the pleats.

2. The recirculation filter of claim 1, in which a stiffening edge is integral to the pleated filtration media.

3. The recirculation filter of claim 1, in which the filtration media comprises a nonwoven media.

4. The recirculation filter of claim 1, in which the filtration media comprises a spun bond media.

5. The recirculation filter of claim 1, in which the filtration media comprises a membrane media.

6. The recirculation filter of claim 1, in which the filtration media comprises an electret media.

7. A disk drive recirculation filter of claim 1 further comprising an adsorbent media or layer.

8. A disk drive recirculation filter of claim 2, further comprising an adsorbent media or layer.

9. A disk drive recirculation filter of claim 3, further comprising an adsorbent media or layer.

10. A disk drive recirculation filter of claim 4, further comprising an adsorbent media or layer.

11. A disk drive recirculation filter of claim 5, further comprising an adsorbent media or layer.

12. A disk drive recirculation filter of claim 6, further comprising an adsorbent media or layer.

13. A disk drive recirculation filter of claim 1, further comprising one or more cover or scrim layers on either or each side of the filter layers.

14. A disk drive recirculation filter of claim 2, further comprising one or more cover or scrim layers on either or each side of the filter layers.

15. A disk drive recirculation filter of claim 3, further comprising one or more cover or scrim layers on either or each side of the filter layers.

16. A disk drive recirculation filter of claim 4, further comprising one or more cover or scrim layers on either or each side of the filter layers.

17. A disk drive recirculation filter of claim 5, further comprising one or more cover or scrim layers on either or each side of the filter layers.

18. A disk drive recirculation filter of claim 6, further comprising one or more cover or scrim layers on either or each side of the filter layers.

19. A disk drive recirculation filter of claim 1, further comprising a sealed edge around the perimeter of the filter.

20. A disk drive recirculation filter of claim 2, further comprising a sealed edge around the perimeter of the filter.

21. A disk drive recirculation filter of claim 3, further comprising a sealed edge around the perimeter of the filter.

22. A disk drive recirculation filter of claim 4, further comprising a sealed edge around the perimeter of the filter.

23. A disk drive recirculation filter of claim 5, further comprising a sealed edge around the perimeter of the filter.

24. A disk drive recirculation filter of claim 6, further comprising a sealed edge around the perimeter of the filter.

25. A disk drive recirculation filter of claim 6, where the filter media comprises one or more layers of an electret filter media.

26. A disk drive recirculation filter of claim 5, where the filter media comprises one or more layers of PTFE membrane filter media.

27. A disk drive recirculation filter of claim 1, further comprising at least one tab extending from said filter.

28. A disk drive recirculation filter of claim 2, further comprising at least one tab extending from said filter.

29. A disk drive recirculation filter of claim 3, further comprising at least one tab extending from said filter.

30. A disk drive recirculation filter of claim 4, further comprising at least one tab extending from said filter.

31. A disk drive recirculation filter of claim 5, further comprising at least one tab extending from said filter.

32. A disk drive recirculation filter of claim 6, further comprising at least one tab extending from said filter.

33. A method of making a recirculation filter for a disk drive comprising the steps of:
a) providing a filtration media sheet
b) pleating the filtration media sheet,
c) sealing the sheet with heat and pressure to define distinct areas of pleated filtration media, each area having pleats interconnected by sealed regions at opposite ends of the pleats, and
d) separating the filtration media at the sealed regions such that two or more areas of pleated filtration media sheet are separated, each separated portion having pleats interconnected by sealed regions.
